(19) United States
(12) Patent Application Publication
(10) Pub. No.: US 2026/0147819 A1
(43) Pub. Date: May 28, 2026

(54) MANAGING OPERATION OF DATA PROCESSING SYSTEMS USING ONTOLOGY-BASED TELEMETRY DATA

(71) Applicant: Dell Products L.P., Round Rock, TX (US)

(72) Inventors: ANDREA ROGGERONE, Dublin (IE); MUZHAR S. KHOKHAR, Shrewsbury, MA (US); VINAY SAWAL, Fremont, CA (US); RAJINI RAMACHANDRAN KARTHIK, Austin, TX (US); BRIAN ROCHFORD, Cork (IE)

(21) Appl. No.: 18/962,716

(22) Filed: Nov. 27, 2024

(51) Int. Cl. G06F 16/36; G06F 16/35; G06F 16/383

(52) U.S. Cl. CPC G06F 16/367; G06F 16/35; G06F 16/383

(57) ABSTRACT

Methods and systems for managing operation of data processing systems are disclosed. A management system may obtain telemetry data based on operation of the data processing systems while using resources managed by the management system. The management system may selectively classify the telemetry data based on criteria and by sampling the telemetry data to indicate a portion of telemetry data to be semantically enriched. The portion of telemetry data may be semantically enriched based on a defined ontology to provide relevant metadata to the portion of telemetry data. The management system may perform a process using the semantically enriched telemetry data to obtain an outcome. The outcome may be used by the management system to update operation of the data processing systems.

### FIELD

Embodiments disclosed herein relate generally to managing operation of data processing systems. More particularly, embodiments disclosed herein relate to managing operation of the data processing systems by using a portion of telemetry data classified to be semantically enriched based on a defined ontology.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. While operating, the data processing systems may utilize resources managed by a management system. The operation of the data processing systems may be managed by performing an update to at least a portion of the data processing systems.

The update may be performed based on a portion of telemetry data obtained by the management system from the data processing systems. The portion of telemetry data may be based on operation of the data processing systems while utilizing resources managed by the management system. Once obtained, it may be determined whether the portion of telemetry data is acceptable for use in a process (e.g., data analysis). Because the data processing systems may operate in any number and/or type of environments, telemetry data generated by the data processing systems may include qualities that may not be acceptable for use in the process.

To determine whether the portion of telemetry data is acceptable for use in the process, the management system may, for example, sample the portion of the telemetry data, identify a ratio between a cardinality of the samples that are usable in the process to a cardinality of the samples, compare the ratio to a threshold ratio (e.g., based on the process), and/or perform any other actions. In an instance of the comparing where the ratio does not meet the threshold ratio, the portion of telemetry data may be classified to indicate that the portion of telemetry data is to be semantically enriched.

To semantically enrich the portion of telemetry data, the management system may obtain a defined ontology that may provide a predefined schema (e.g., controlled vocabulary, domain knowledge, data format, etc.) for annotating the portion of telemetry data with metadata to obtain semantically enriched telemetry data. For example, existing metadata relevant to the portion of telemetry data may be replaced with new metadata based on the defined ontology, different metadata may be added to the existing metadata based on the defined ontology, and/or any other processes may be performed.

By doing so, processes (e.g., data integration, querying, analysis, etc.) may be performed using the semantically enriched telemetry data that may provide more relevant results than second processes performed using telemetry data that is not semantically enriched. The more relevant results may subsequently be used in updating operation of the data processing systems to provide improved computer-implemented services.

Thus, embodiments disclosed herein may provide an improved method for managing operation of data processing systems by selectively enriching telemetry data based on a defined ontology to obtain semantically enriched telemetry data. The selectively enriched telemetry data may provide more relevant information for updating operation of the data processing systems. By doing so, a quality of computer-implemented services provided by the updated data processing systems may be improved.

In an embodiment, a method for managing operation of data processing systems is provided. The method may include: (i) obtaining, by a management system, at least a portion of telemetry data generated by the data processing systems, the portion of telemetry data being indicated as requiring semantic enrichment based on semantic enrichment classifications; (ii) obtaining, by the management system and using the portion of telemetry data, semantically enriched telemetry data based on a defined ontology; (iii) analyzing, by the management system, the semantically enriched telemetry data to obtain an analysis outcome; (iv) updating operation of the data processing systems based on the analysis outcome to obtain updated data processing systems; and (v) providing computer-implemented services using the updated data processing systems.

The method may also include: prior to obtaining the at least the portion of the telemetry data: (i) obtaining, by the management system, a second portion of telemetry data from the data processing systems, the second portion of telemetry data being based on operation of the data processing systems; (ii) making, by the management system, a determination regarding whether the second portion of telemetry data is acceptable for use in a process; and (iii) in a first instance of the determination where the second portion of the telemetry data is not acceptable: (a) establishing at least one of the semantic enrichment classifications based on the determination, the at least one of the semantic enrichment classifications indicating that the portion of the telemetry data is to be semantically enriched.

Making the determination may include: (i) sampling the second portion of the telemetry data to obtain samples; (ii) identifying a ratio between a cardinality of a first portion of the samples that are usable in the process to a cardinality of the samples; (iii) comparing the ratio to a threshold ratio; and (iv) in an instance of the comparing where the ratio does not meet the threshold ratio: (a) concluding that the second portion of the telemetry data is not acceptable for use in the process.

The threshold ratio may be based on the process, and different threshold ratios may be associated with different processes based on data needs of the different processes.

The semantic enrichment classifications may be based, at least in part, on an unacceptable usability of the at least the portion of the telemetry data in a process, and the semantically enriched telemetry data being acceptably usable in the process.

The process may presume that a first set of metadata for the at least the portion of the telemetry data is available, and the at least the portion of the telemetry data lacks at least a portion of the first set of metadata due to a different defined ontology used in generating metadata for the at least the portion of the telemetry data.

The at least the portion of the telemetry data may be deemed to have an unacceptable usability due to a magnitude of difference between the different defined ontology and the defined ontology.

Analyzing the semantically enriched telemetry data may include: (i) generating a dashboard based on the semantically enriched telemetry data; and (ii) obtaining user input via the dashboard.

Updating the operation of the data processing systems may include modifying operation of at least one of the data processing systems based on the user input.

Obtaining the semantically enriched telemetry data based on the defined ontology may include at least one selected from a list of operations consisting of: (i) replacing existing metadata with new metadata based on the defined ontology; (ii) adding different metadata based on the defined ontology to the existing metadata.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

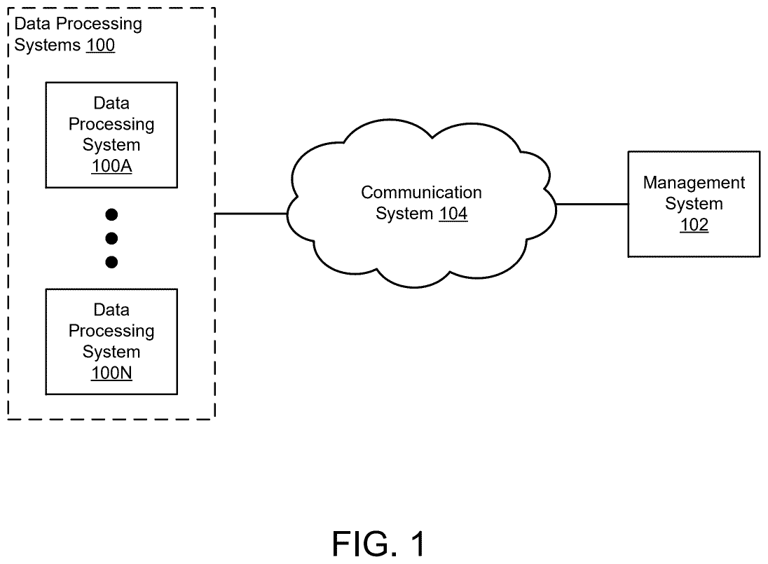

Turning to FIG. 1, a block diagram illustrating a system in accordance with an embodiment is shown. The system shown in FIG. 1 may provide for management of data processing systems that may provide, at least in part, computer-implemented services (e.g., to user of the system and/or devices operably connected to the system).

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

To provide at least a portion of the computer-implemented services, the data processing systems may use resources hosted and/or managed by a management system. The resources may include, for example, cloud services, computational resources, data storage, and/or any other resources that may support operation of the data processing systems. Based on a request to service at least a portion of the data processing systems, the management system may update operation of the portion of data processing systems.

To update the operation of the portion of data processing systems, the management system may perform processes using at least a portion of telemetry data obtained from the portion of data processing systems. For example, the management system may aggregate any number and/or type of telemetry data, analyze the telemetry data to obtain an analysis outcome, monitor performance of the portion of data processing systems based on the telemetry data, and/or perform any other actions to identify an update to the portion of data processing systems based on the telemetry data.

However, because the data processing systems may operate in various environments and/or domains, telemetry data obtained from the data processing systems may provide limited information usable by the management system to obtain relevant results when performing a process (e.g., data analysis) using the telemetry data. For example, data processing systems operating using different architectures (e.g., on premise, public cloud, etc.) and/or different domains may organize data in different manners (e.g., different data types, vocabulary, etc.). By operating as such, an ability of the management system to process the telemetry data obtained from the different data processing systems for obtaining an analysis outcome may be negatively impacted.

To improve a likelihood that the management system may obtain relevant results from a process using the telemetry data, the telemetry data may be semantically enriched using a defined ontology. The defined ontology may provide more relevant metadata that may be applied to the telemetry data. To apply the defined ontology to at least a portion of telemetry data, the management system may perform computational processes based on the portion of telemetry data and the defined ontology. Because a quantity of telemetry data obtained by management system may be higher than compute resources available to the management system and/or a portion of the telemetry data obtained by management system may already be acceptable for use in a process, an ability of the management system to perform management functions for the data processing systems may further be negatively impacted due to unnecessary computational processes performed to semantically enrich telemetry data (e.g., all telemetry data) obtained from the data processing systems.

In general, embodiments disclosed herein may provide methods, systems, and/or devices for managing data processing systems. To improve an ability of a management system to identify updates for a portion of the data processing systems, the management system may perform a process based on a portion of selectively classified and/or semantically enriched telemetry data obtained from the data processing systems.

To obtain the semantically enriched telemetry data, the management system may obtain a portion of telemetry data from the data processing systems relevant to operation of the data processing systems while using the resources managed by the management system. For example, the data processing systems may generate and/or collect system health metrics, sensor data, event logs, activity data, and/or any other information that the management system may be subscribed to. The data processing systems may subsequently transmit at least a portion of the telemetry data to the management system (e.g., via a secure communication channel).

Once obtained, it may be determined whether the portion of telemetry data is acceptable for use in a process (e.g., data analysis). Because the data processing systems may operate in any number and/or type of environments, telemetry data generated by the data processing systems may include qualities that may not be acceptable for use in the process.

To determine whether the portion of telemetry data is acceptable for use in the process, the management system may, for example, sample the portion of the telemetry data, identify a ratio between a cardinality of the samples that are usable in the process to a cardinality of the samples, compare the ratio to a threshold ratio (e.g., based on the process), and/or perform any other actions to identify a magnitude of difference between an ontology of the samples and a defined ontology. In an instance of the comparing where the ratio does not meet the threshold ratio, the portion of telemetry data may be classified to indicate that the portion of telemetry data is to be semantically enriched.

The telemetry data may be ingested and/or aggregated by the management system to prepare the telemetry data for semantic enrichment and/or inferencing. For example, the telemetry data may be cleaned, normalized, data fields may be identified, and/or any other processes may be performed. The telemetry data may subsequently be mapped based on a defined ontology.

The defined ontology may be obtained and/or generated by the management system. For example, the management system may obtain a predefined ontology (e.g., managed by a remote entity) relevant for a domain of resources managed by the management system and/or the defined ontology may be generated (e.g., by a subject matter expert) based on knowledge of key concepts, relationships, and hierarchical structures relevant to the domain. Furthermore, the defined ontology may be updated at any time based on new information identified by an entity tasked with managing the defined ontology.

Using the defined ontology, resources indicated by the telemetry data may be mapped according to the predefined schema. For example, the telemetry data may be mapped based on a class element (e.g., a resource type), properties (e.g., relationships between class elements), and logical constraints defined by the schema that indicate a structure of the telemetry data. Additionally, new metadata relevant to the telemetry data may be added (e.g., via annotations) and/or replaced based on the defined ontology.

To semantically enrich the portion of telemetry data, the management system may obtain a defined ontology that may provide a predefined schema (e.g., controlled vocabulary, domain knowledge, data format, etc.) for annotating the portion of telemetry data with metadata to obtain semantically enriched telemetry data. For example, existing metadata relevant to the portion of telemetry data may be replaced with new metadata based on the defined ontology, different metadata may be added to the existing metadata based on the defined ontology, and/or any other processes may be performed.

The management system may subsequently perform any number and/or type of processes using the semantically enriched telemetry data. For example, the management system may integrate the semantically enriched telemetry data from distributed data sources, employ a federated query engine, perform data analysis (e.g., inferencing, statistical analysis, etc.) using the semantically enriched telemetry data to obtain an analysis outcome, generate a dashboard based on the semantically enriched telemetry data and/or the analysis outcome, and/or perform any other actions.

By doing so, the processes performed using the semantically enriched telemetry data may provide more relevant results than second processes performed using telemetry data that is not semantically enriched. The more relevant results may subsequently be used in updating operation of the data processing systems to provide improved computer-implemented services.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing systems 100). To do so, data processing systems 100 may utilize resources that may be managed by management system 102. For example, data processing systems 100 may access software and/or other resources (e.g., compute power, storage, networking, etc.) hosted on servers (e.g., cloud servers) to provide the portion of computer-implemented services. While utilizing the resources, data processing systems may collect (e.g., using software agents hosted by the data processing systems) telemetry data relevant to use of the resources and/or communicate the telemetry data to management system 102.

As discussed above, management system 102 may provide resource management services. To provide the resource management services, management system 102 may (i) obtain at least a portion of telemetry data from data processing systems 100, (ii) classify the portion of telemetry data to be semantically enriched based on criteria (e.g., a threshold ratio of telemetry data acceptable for use in a certain process), (iii) obtain and/or apply a defined ontology to the telemetry data to obtain semantically enriched telemetry data, (iv) analyze the semantically enriched telemetry data to obtain an analysis result, and/or perform any other actions. By doing so, management system may identify actions to perform to update operation of at least a portion of data processing systems 100 to obtain updated data processing systems.

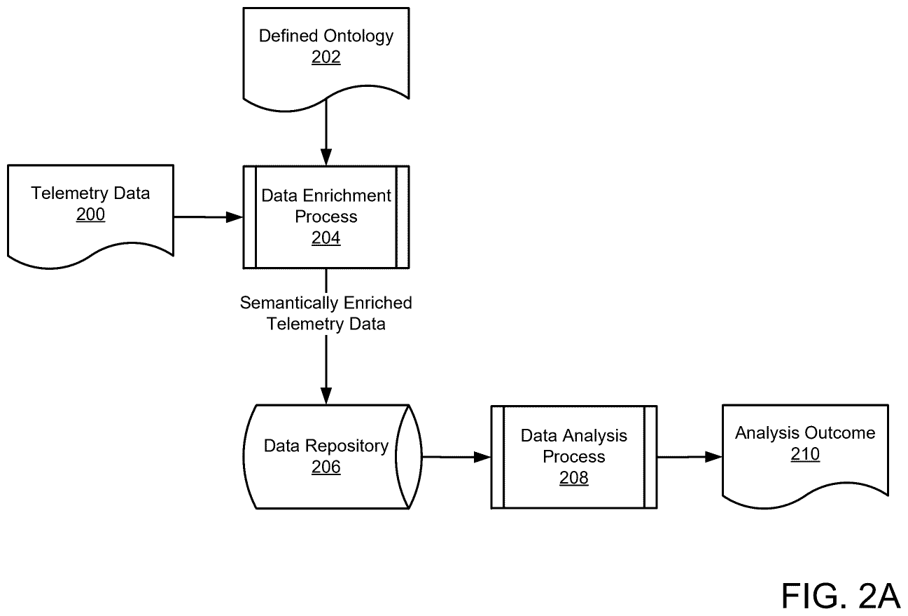

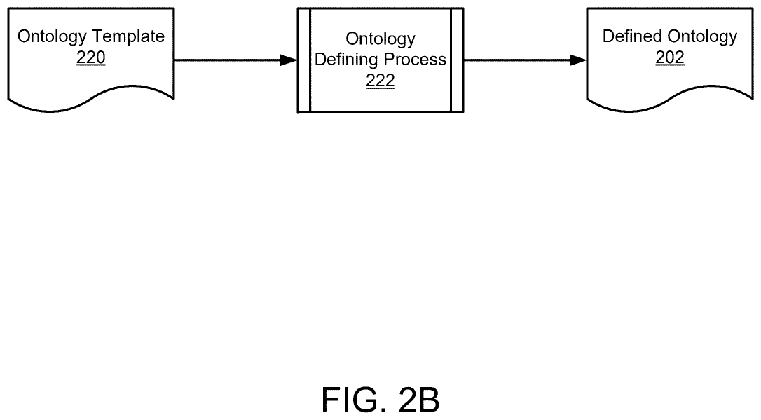

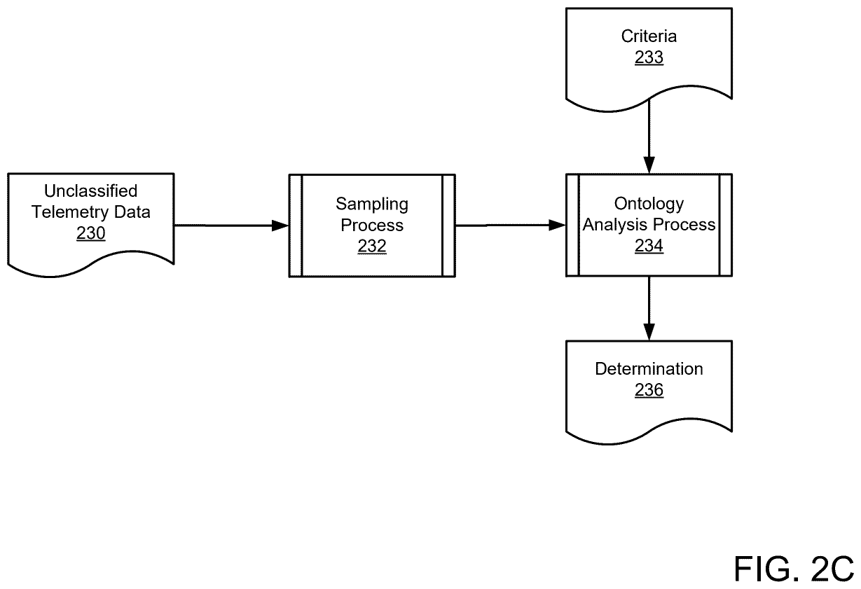

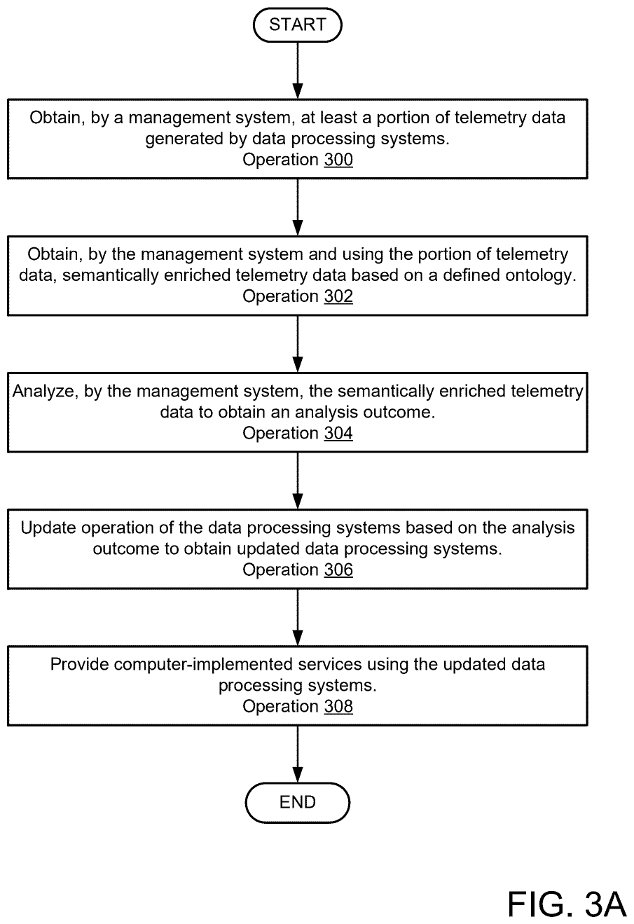

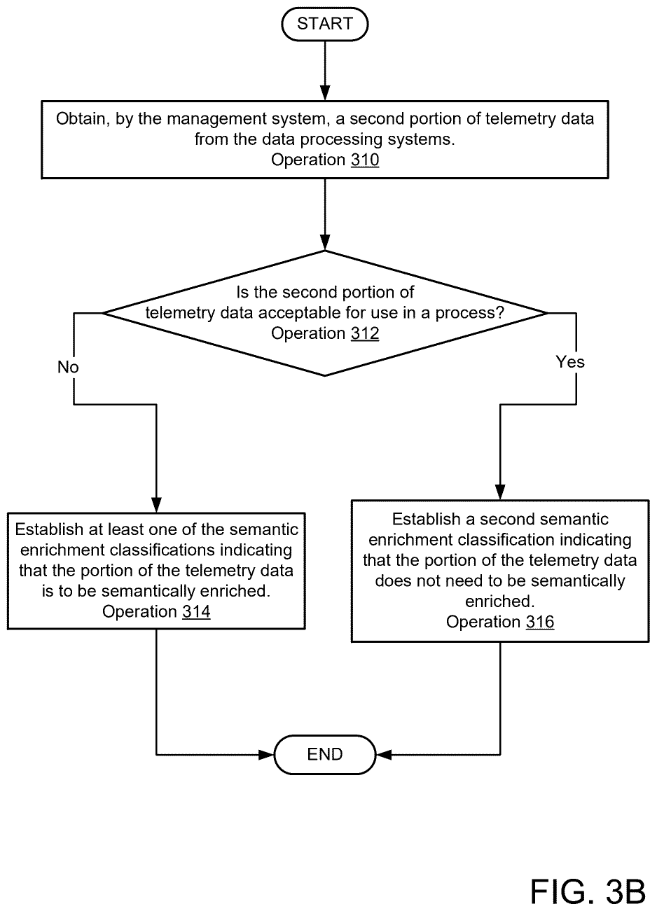

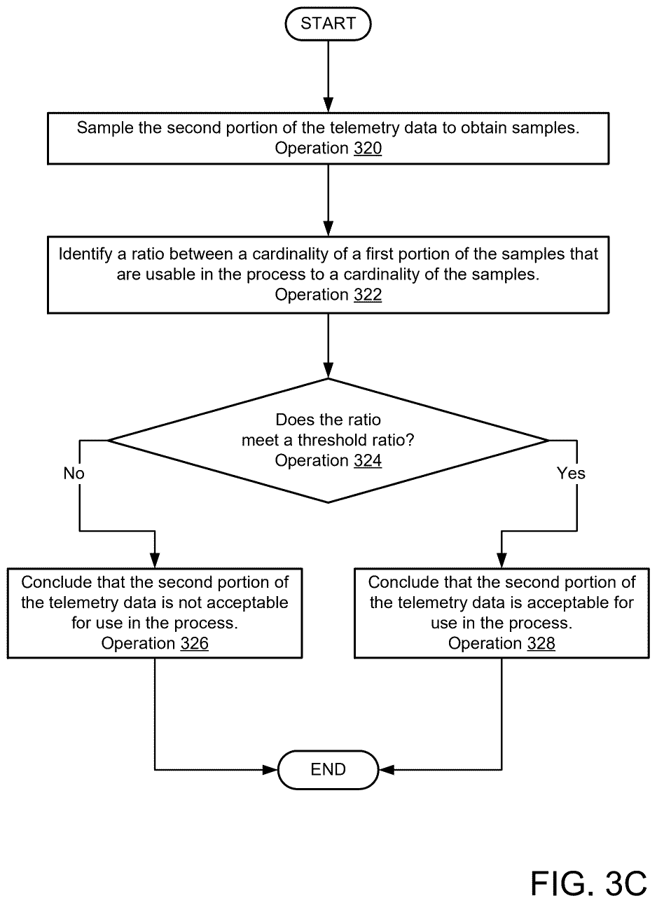

While providing their functionality, any of data processing systems 100 and/or management system 102 may provide all or a portion of the methods shown in FIGS. 2A-3C.

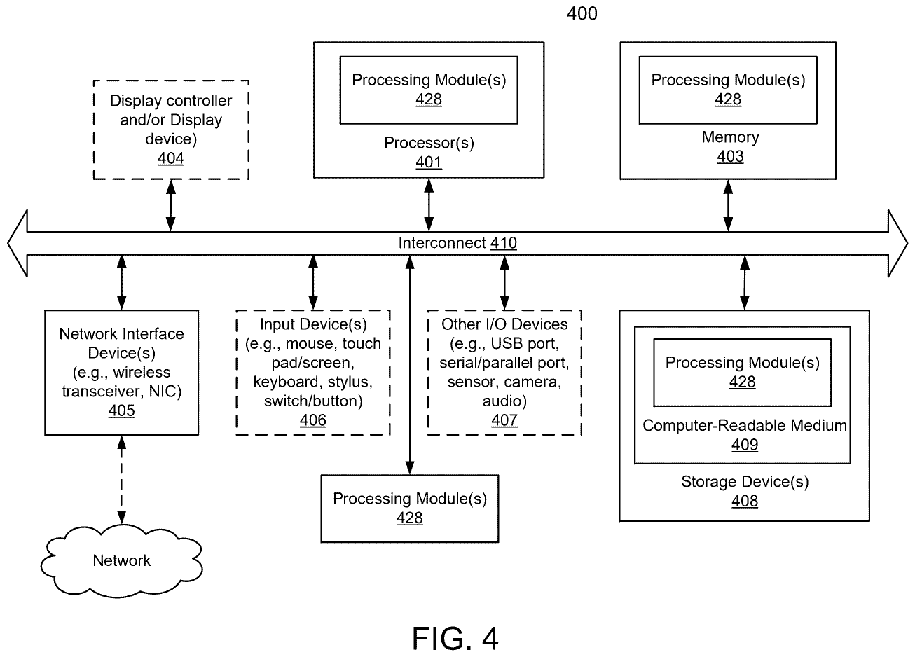

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of data processing systems by using a management system to analyze telemetry data selectively classified to be semantically enriched based on a defined ontology. By doing so, an ability of a management system to update operation of data processing systems may be improved.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 202, etc.) is used to represent data structures, a second set of shapes (e.g., 204, 208, etc.) is used to represent processes performed using and/or that generate data, and a third set of shapes (e.g., 206) is used to represent large scale data structures such as databases.

Turning to FIG. 2A, a first data flow diagram in accordance with an embodiment is shown. The first data flow diagram may illustrate data used in and data processing performed in obtaining an analysis outcome based on semantically enriched telemetry data.

Telemetry data 200 may include any number and type of data related to resources used by data processing systems 100. For example, telemetry data 200 may include resource name, resource type, usage statistics, relationships, descriptions, and/or any other information. Telemetry data 200 may be obtained by data processing systems 100, for example, using agents that may collect data (e.g., telemetry data, raw data, etc.) of the resources and transmit the data to management system 102 via a secure communication channel.

Defined ontology 202 may include any number and type of information related to a predefined schema for semantically enriching portions of telemetry data 200. For example, defined ontology 202 may be implemented using an ontology language model (e.g., web ontology language, resource description framework schema, etc.), a directed graph data structure, a hierarchical data structure, triples, and/or any other structures. Furthermore, defined ontology 202 may provide domain specific information usable to define relationships between the portions of telemetry data 200. For example, defined ontology 202 may include vocabulary, logical expressions, properties, and/or any other attributes that may provide semantic context for telemetry data 200. Refer to FIG. 2B for additional details regarding obtaining defined ontology 202.

To obtain the analysis outcome based on semantically enriched telemetry data, data enrichment process 204 may be performed. During data enrichment process 204, defined ontology 202 may be applied to telemetry data 200. For example, to apply defined ontology 202, (i) different semantic metadata (e.g., relationships, contextual information, etc.) may be added to existing metadata for portions of telemetry data 200, (ii) existing metadata of telemetry data 200 may be replaced with new metadata based on defined ontology 202, (iii) vocabulary used based on various data sources may be aligned to shared concepts defined by defined ontology 202, and/or any other processes to obtain semantically enriched telemetry data. Once obtained, the semantically enriched telemetry data may be stored in data repository 206 for subsequent use in analyzing the semantically enriched telemetry data.

Data repository 206 may include any number and type of storage for semantically enriched telemetry data relevant to telemetry data 200. For example, data repository 206 may include a set of distributed databases, a centralized database, graph databases, and/or any other storage accessible by management system 102.

To obtain an analysis outcome, data analysis process 208 may be performed. During data analysis process 208, semantically enriched telemetry data may be ingested from data repository 206, and the semantically enriched telemetry data may be processed by management system 102. For example, to ingest the semantically enriched telemetry data, (i) any number and/or types of data sources may be integrated (e.g., via centralized data storage, application programming interface integration, etc.), (ii) federated queries may be employed to facilitate access to the semantically enriched telemetry data from data repository 206, (iii) the semantically enriched telemetry data may be stored, at least temporarily, in a storage hosted by management system 102, and/or any other processes may be performed.

Once ingested, the semantically enriched telemetry data may be processed by management system 102. For example, to process the semantically enriched telemetry data, management system 102 may (i) perform computational analysis (e.g., statistical analysis, correlation analysis, etc.) on the semantically enriched telemetry data, (ii) detect anomalies based on the semantically enriched telemetry data that may be identified for additional investigation, (iii) generate inferences (e.g., using an inference model) based on the semantically enriched telemetry data, (iv) generate visualizations based on the semantically enriched telemetry data and/or analysis of the semantically enriched telemetry data, and/or perform any other actions.

Analysis outcome 210 may include any type and/or quantity of information regarding an outcome of data analysis process 208. For example, analysis outcome 210 may include (i) a dashboard generated based on the semantically enriched telemetry data, (ii) instructions for at least one action to perform based on a result of data analysis performed using the semantically enriched telemetry data, (iii) a report generated relevant to operation of a portion of the resources associated with telemetry data 200, and/or any other information. Analysis outcome 210 may subsequently be used in updating operation of at least a portion of data processing systems 100.

Thus, using the data flow shown in FIG. 2A, telemetry data obtained by a management system and from data processing systems may be semantically enriched using a defined ontology. The semantically enriched telemetry data may be used to obtain an analysis outcome usable to update operation of the data processing systems. By doing so, the updated data processing systems may provide improved computer-implemented services.

Turning to FIG. 2B, a second data flow diagram in accordance with an embodiment is shown. The second data flow diagram may illustrate data used in and data processing performed in obtaining a defined ontology for use in semantically enriching telemetry data obtained from data processing systems 100.

Ontology template 220 may include any number and type of information related to a predefined schema for describing telemetry data. For example, ontology template 220 may be implemented using an ontology language model (e.g., web ontology language, resource description framework schema, etc.) that may define a format for describing features of a resource (e.g., a sensor, a compute resource, etc.), observations (e.g., metrics, logs, etc.), properties of the observations, and/or any other information. Ontology template 220 may be obtained by management system 102 based on an existing ontology (e.g., semantic sensor network ontology, sensor observation sample and actuator ontology, etc.) that may be provided, for example, by a remote entity.

To obtain the defined ontology, ontology defining process 222 may be performed. During ontology defining process 222, ontology template 220 may be extended to improve semantic enrichment capabilities of ontology template 220 when used by management system 102. For example, to extend ontology template 220, (i) domain specific metadata may be added to ontology template 220 (e.g., by a subject matter expert), (ii) new properties and relationships may be defined that be more relevant to a portion of telemetry data obtained by management system 102, (iii) rules may be established to improve logical consistency between a telemetry data obtained from a plurality of data sources, and/or any other actions may be performed.

Defined ontology 202 may, as previously discussed, include any number and type of information related to a predefined schema for semantically enriching portions of telemetry data obtained by management system 102. For example, defined ontology 202 may include a first ontology for telemetry data obtained from a first portion of data processing systems 100 that operate in a first domain, a second ontology for telemetry data obtained from a second portion of data processing systems 100 that operate in a second domain, and/or any other information. By obtaining defined ontology 202, management system 102 may manage operation of data processing systems based on semantically enriched telemetry data obtained from the data processing systems.

Thus, using the data flow shown in FIG. 2B, a defined ontology may be obtained relevant to telemetry data obtained by a management system. The defined ontology may be used to provide enhanced information regarding the telemetry data. By doing so, an ability of a management system to identify updates for data processing systems based on the enhanced information may be improved.

Turning to FIG. 2C, a third data flow diagram in accordance with an embodiment is shown. The third data flow diagram may illustrate data used in and data processing performed in establishing semantic enrichment classifications for portions of telemetry data obtained by management system 102 and from data processing systems 100.

Unclassified telemetry data 230 may include any number and type of data related to operation of data processing systems 100. For example, unclassified telemetry data 230 may include operational status of a data processing system of data processing systems 100, system health metrics, sensor data, event logs, activity data, and/or any other information. Unclassified telemetry data 230 may be generated by data processing systems 100, for example, using a software agent that may collect data (e.g., telemetry data, raw data, etc.) during operation of data processing systems 100. Unclassified telemetry data 230 may subsequently be transmitted to management system 102 from data processing systems 100 (e.g., via a secure communication channel).

To establish semantic enrichment classifications for the portions of telemetry data, sampling process 232 may be performed. During sampling process 232, a subset of unclassified telemetry data 230 may be identified. For example, to identify the subset of unclassified telemetry data 230, management system 102 may (i) employ a probabilistic sampling algorithm (e.g., random sampling, systemic sampling, etc.) to select the subset of unclassified telemetry data 230, (ii) identify, based on a quality of a portion of unclassified telemetry data 230 (e.g., an identify of a data source), the portion of unclassified telemetry data 230, and/or perform any other actions. By identifying the subset of unclassified telemetry data 230, management system 102 may determine whether a portion of telemetry data obtained from data processing systems 100 may be acceptable for use in a process.

Criteria 233 may include any number and/or type of information regarding requirements relevant to acceptability of telemetry data for use in a certain process. For example, criteria 233 may include a threshold ratio (e.g., a percentage of sampled telemetry data that meets ontology standards) based on a process and/or data needs of the process. Criteria 233 may be defined by an entity (e.g., a subject matter expert) tasked with managing operation of management system 102. Additionally, criteria 233 may include references to a plurality of defined ontologies with which an ontology of a sampled portion of telemetry data may be compared based on, for example, a domain of the sampled portion of telemetry data.

To determine whether the portion of telemetry data is acceptable for use in a process, ontology analysis process 234 may be performed. During ontology analysis process 234, a cardinality of a usable portion of telemetry data may be identified, and the cardinality of the usable portion of telemetry data may be compared to criteria 233. For example, the cardinality of a usable portion of telemetry data may be identified by (i) performing validation tests (e.g., completeness, relevance, accuracy, etc.) using a sampled portion of unclassified telemetry data 230, (ii) assessing a quality of mapping the sampled portion of unclassified telemetry data 230 to a defined ontology, (iii) aggregating results of validation tests, and/or any other processes.

Once identified, the cardinality of the usable portion of the telemetry data may be compared to criteria 233. For example, the cardinality of the usable portion of the telemetry data may be compared by (i) identifying a ratio between the cardinality of the usable portion to a cardinality of the sampled portion of unclassified telemetry data 230, (ii) comparing the ratio to a threshold ratio indicated by criteria 233, (iii) inferring a semantic enrichment classification for the sampled portion of unclassified telemetry data 230 based on criteria 233, and/or any other processes. By doing so, a determination may be made regarding whether unclassified telemetry data 230 may be acceptable for use in a process by management system 102.

Determination 236 may include any number and/or type of information regarding a classification for semantically enriching unclassified telemetry data 230. For example, determination 236 may include instructions for management system 102 to semantically enrich unclassified telemetry data 230. Alternatively, determination 236 may include second instructions for management system 102 to not utilize unclassified telemetry data 230 based on a conclusion that unclassified telemetry data 230 is unacceptable for use in the process.

Thus, using the data flow shown in FIG. 2C, a determination may be made regarding whether a portion of telemetry data obtained by a management system and from data processing systems may be acceptable for use in a process (e.g., data analysis) based on an ontology of the portion of telemetry data. By doing so, the process may be performed using an acceptable portion of the telemetry data that may improve an ability of the management system to manage the data processing systems.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of managing operation of data processing systems in accordance with an embodiment is shown. The method may be performed, for example, by any of the components of the system of FIG. 1, and/or other components not shown therein.

Prior to operation 300, semantic enrichment classifications may be established based on telemetry data obtained by a management system and from data processing systems. Refer to FIG. 2B for additional details regarding establishing the semantic enrichment classifications.

At operation 300, at least a portion of telemetry data generated by the data processing systems may be obtained by the management system. The at least the portion of telemetry data may be obtained by: (i) collecting telemetry data (e.g., metrics, logs, observations, etc.) on each data processing system of the data processing systems using a software agent (e.g., OpenTelemetry) hosted by the each data processing system, (ii) transmitting the telemetry data via a secure communication channel to the management system, (iii) storing the telemetry data in storage for subsequent retrieval at scheduled intervals by the management system, and/or any other processes.

At operation 302, semantically enriched telemetry data may be obtained using the portion of telemetry data and based on a defined ontology. The semantically enriched telemetry data may be obtained by: (i) adding metadata based on the defined ontology to the portion of telemetry data, (ii) mapping elements (e.g., classes, properties, attributes, etc.) indicated by the portion of telemetry data to a corresponding element of the defined ontology, (iii) aligning vocabulary used based on various data sources to shared concepts defined by defined ontology, (iv) formatting a hierarchical structure (e.g., properties, sub-properties, etc.) according to the defined ontology, and/or any other processes.

At operation 304, the semantically enriched telemetry data may be analyzed by the management system to obtain an analysis outcome. The semantically enriched telemetry data may be analyzed by: (i) ingesting the semantically enriched telemetry data from any number of data sources (e.g., distributed data repositories), (ii) issuing queries using a federated query engine to obtain integrated semantically enriched telemetry data, (iii) performing statistical analysis based on the semantically enriched telemetry data to obtain insights relevant to operation of the data processing systems, (iv) generating a dashboard based on the semantically enriched telemetry data (e.g., to provide visualization of the semantically enriched telemetry data and/or results of the statistical analysis), and/or performing any other actions.

At operation 306, operation of the data processing systems may be updated based on the analysis outcome to obtain updated data processing systems. The operation of the data processing systems may be updated by: (i) obtaining user input via a dashboard generated based on the semantically enriched telemetry data and/or the analysis outcome, (ii) modifying a configuration of the resources based on the analysis outcome and/or the user input, (iii) enforcing a policy on an identified portion of the resources, (iv) enabling and/or restricting access to resources based on the analysis outcome, and/or performing any other actions.

At operation 308, computer-implemented services may be provided using the updated data processing systems. The computer-implemented services may be provided by: (i) installing and/or updating software relevant to the resources on the data processing systems, (ii) executing instructions specified by the updated software on the other data processing systems, (iii) monitoring for new telemetry data collected by the data processing systems while using updated resources, and/or any other processes.

The method may end following operation 308.

Using the method shown in FIG. 3A, operation of data processing systems may be managed by a management system based on semantically enriched telemetry data obtained based on operation of the data processing systems. By using the semantically enriched telemetry data, the management system may obtain an analysis outcome that may be more relevant and/or be of higher quality than a second analysis outcome obtained based on telemetry data that is not semantically enriched.

Turning to FIG. 3B, a second flow diagram illustrating a method of establishing semantic enrichment classifications based on a portion of telemetry data in accordance with an embodiment is shown. The method may be performed, for example, by any of the components of the system of FIG. 1, and/or other components not shown therein.

At operation 310, a second portion of telemetry data may be obtained by the management system and from the data processing systems.

At operation 312, a determination may be made regarding whether the second portion of telemetry data is acceptable for use in a process. The determination may be made by: (i) sampling the second portion of the telemetry data to obtain samples, (ii) comparing the samples to criteria, (iii) identifying a magnitude of difference between an ontology of the samples and a defined ontology, and/or any other processes. Refer to FIG. 3C for additional details regarding making the determination. If the second portion of telemetry data is not acceptable for use in the process (e.g., the determination is “No” at operation 312), then the method may proceed to operation 314. If the second portion of telemetry data is acceptable for use in the process (e.g., the determination is “Yes” at operation 312), then the method may proceed to operation 316.

At operation 314, at least one of the semantic enrichment classifications may be established to indicate that the portion of the telemetry data is to be semantically enriched. The at least one of the semantic enrichment classifications may be established by (i) labeling the portion of telemetry data for semantic enrichment, (ii) positioning the portion of telemetry in a process queue to be semantically enriched, and/or any other processes.

The method may end following operation 314.

Returning to operation 312, the method may proceed to operation 316 following operation 312 when the second portion of telemetry data is acceptable for use in the process.

At operation 316, a second semantic enrichment classification may be established to indicate that the portion of telemetry data does not need to be semantically enriched. The second semantic enrichment classification may be established by (i) labeling the portion of telemetry data as not needing semantic enrichment, (ii) approving the portion of telemetry data for use in the process, and/or any other processes.

The method may end following operation 316.

Thus, using the method shown in FIG. 3B, a portion of telemetry data may be classified to be semantically enriched. By doing so, the management system may selectively apply semantic enrichment to classified portions of telemetry data.

Turning to FIG. 3C, a third flow diagram illustrating a method of making a determination regarding whether a portion of telemetry data is acceptable for use in a process in accordance with an embodiment is shown. The method may be performed, for example, by any of the components of the system of FIG. 1, and/or other components not shown therein.

At operation 320, the second portion of the telemetry data may be sampled to obtain samples. The second portion of telemetry data may be sampled by (i) randomly selecting subsets of telemetry data obtained from the data processing systems, (ii) selecting subsets of telemetry data based on an inferred likelihood that the telemetry data may include metadata corresponding to the defined ontology (e.g., based on an identify of a data source), and/or any other processes.

At operation 322, a ratio between a cardinality of a first portion of samples that are usable in the process to a cardinality of the samples may be identified. The ratio may be identified by (i) performing validation tests (e.g., completeness, relevance, accuracy, coverage, etc.) using the samples, (ii) assessing a quality of mapping the samples to a defined ontology, (iii) aggregating results of validation tests, and/or any other processes.

At operation 324, a comparison may be made to identify whether the ratio meets a threshold ratio. The comparison may be made by (i) identifying a threshold ratio associated with a process desired to be performed using the portion of telemetry data, (ii) comparing the ratio to the threshold ratio indicated by criteria defined by an entity tasked with operating the management system, and/or performing any other actions. If the ratio does not meet the threshold ratio (e.g., the determination is “No” at operation 324), then the method may proceed to operation 326. If ratio meets the threshold ratio (e.g., the determination is “Yes” at operation 324), then the method may proceed to operation 328.

At operation 326, the second portion of the telemetry data may be concluded to not be acceptable for use in the process. The second portion of the telemetry data may be concluded to not be acceptable by (i) obtaining the result of the comparison, (ii) labeling the second portion of the telemetry data with a classification for semantic enrichment, and/or any other processes.

The method may end following operation 326.

Returning to operation 324, the method may proceed to operation 328 following operation 324 when the ratio meets the threshold ratio.

At operation 328, the second portion of the telemetry data may be concluded to be acceptable for use in the process. The second portion of the telemetry data may be concluded to be acceptable by (i) obtaining the result of the comparison, (ii) approving the second portion of the telemetry data for use in the process, and/or any other processes.

The operation may end following operation 328.

Thus, using the method shown in FIG. 3C, a portion of telemetry data may be sampled and/or compared to criteria relevant to a process that may use the portion of telemetry data. By doing so, the portion of telemetry data may be classified to be semantically enriched for use in improved analysis by a management system.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of data processing systems, the method comprising:
obtaining, by a management system, at least a portion of telemetry data generated by the data processing systems, the portion of telemetry data being indicated as requiring semantic enrichment based on semantic enrichment classifications;
obtaining, by the management system and using the portion of telemetry data, semantically enriched telemetry data based on a defined ontology;
analyzing, by the management system, the semantically enriched telemetry data to obtain an analysis outcome;
updating operation of the data processing systems based on the analysis outcome to obtain updated data processing systems; and
providing computer-implemented services using the updated data processing systems.

2. The method of claim 1, further comprising:
prior to obtaining the at least the portion of the telemetry data:
obtaining, by the management system, a second portion of telemetry data from the data processing systems, the second portion of telemetry data being based on operation of the data processing systems;
making, by the management system, a determination regarding whether the second portion of telemetry data is acceptable for use in a process; and
in a first instance of the determination where the second portion of the telemetry data is not acceptable:
establishing at least one of the semantic enrichment classifications based on the determination, the at least one of the semantic enrichment classifications indicating that the portion of the telemetry data is to be semantically enriched.

3. The method of claim 2, wherein making the determination comprises:
sampling the second portion of the telemetry data to obtain samples;
identifying a ratio between a cardinality of a first portion of the samples that are usable in the process to a cardinality of the samples;
comparing the ratio to a threshold ratio; and
in an instance of the comparing where the ratio does not meet the threshold ratio:
concluding that the second portion of the telemetry data is not acceptable for use in the process.

4. The method of claim 3, wherein the threshold ratio is based on the process, and different threshold ratios are associated with different processes based on data needs of the different processes.

5. The method of claim 1, where the semantic enrichment classifications are based, at least in part, on an unacceptable usability of the at least the portion of the telemetry data in a process, and the semantically enriched telemetry data being acceptably usable in the process.

6. The method of claim 3, wherein the process presumes that a first set of metadata for the at least the portion of the telemetry data is available, and the at least the portion of the telemetry data lacks at least a portion of the first set of metadata due to a different defined ontology used in generating metadata for the at least the portion of the telemetry data.

7. The method of claim 4, wherein the at least the portion of the telemetry data is deemed to have an unacceptable usability due to a magnitude of difference between a different defined ontology and the defined ontology.

8. The method of claim 1, wherein analyzing the semantically enriched telemetry data comprises:
generating a dashboard based on the semantically enriched telemetry data; and
obtaining user input via the dashboard.

9. The method of claim 8, wherein updating the operation of the data processing systems comprises:
modifying operation of at least one of the data processing systems based on the user input.

10. The method of claim 1, wherein obtaining the semantically enriched telemetry data based on the defined ontology comprises at least one selected from a list of operations consisting of:
replacing existing metadata with new metadata based on the defined ontology; and
adding different metadata based on the defined ontology to the existing metadata.

11. A non-transitory machine-readable medium having instructions stored therein, which when executed by a processor, cause the processor to perform operations for managing operation of data processing systems, the operations comprising:
obtaining, by a management system, at least a portion of telemetry data generated by the data processing systems, the portion of telemetry data being indicated as requiring semantic enrichment based on semantic enrichment classifications;
obtaining, by the management system and using the portion of telemetry data, semantically enriched telemetry data based on a defined ontology;
analyzing, by the management system, the semantically enriched telemetry data to obtain an analysis outcome;
updating operation of the data processing systems based on the analysis outcome to obtain updated data processing systems; and
providing computer-implemented services using the updated data processing systems.

12. The non-transitory machine-readable medium of claim 11, wherein the operations further comprise:
prior to obtaining the at least the portion of the telemetry data:
obtaining, by the management system, a second portion of telemetry data from the data processing systems, the second portion of telemetry data being based on operation of the data processing systems;
making, by the management system, a determination regarding whether the second portion of telemetry data is acceptable for use in a process; and
in a first instance of the determination where the second portion of the telemetry data is not acceptable:
establishing at least one of the semantic enrichment classifications based on the determination, the at least one of the semantic enrichment classifications indicating that the portion of the telemetry data is to be semantically enriched.

13. The non-transitory machine-readable medium of claim 12, wherein making the determination comprises:
sampling the second portion of the telemetry data to obtain samples;
identifying a ratio between a cardinality of a first portion of the samples that are usable in the process to a cardinality of the samples;
comparing the ratio to a threshold ratio; and
in an instance of the comparing where the ratio does not meet the threshold ratio:
concluding that the second portion of the telemetry data is not acceptable for use in the process.

14. The non-transitory machine-readable medium of claim 13, wherein the threshold ratio is based on the process, and different threshold ratios are associated with different processes based on data needs of the different processes.

15. The non-transitory machine-readable medium of claim 11, wherein the semantic enrichment classifications are based, at least in part, on an unacceptable usability of the at least the portion of the telemetry data in a process, and the semantically enriched telemetry data being acceptably usable in the process.

16. A data processing system, comprising:
a processor; and
a memory coupled to the processor to store instructions, which when executed by the processor, cause the processor to perform operations for managing operation of data processing systems, the operations comprising:
obtaining, by a management system, at least a portion of telemetry data generated by the data processing systems, the portion of telemetry data being indicated as requiring semantic enrichment based on semantic enrichment classifications;
obtaining, by the management system and using the portion of telemetry data, semantically enriched telemetry data based on a defined ontology;
analyzing, by the management system, the semantically enriched telemetry data to obtain an analysis outcome;
updating operation of the data processing systems based on the analysis outcome to obtain updated data processing systems; and
providing computer-implemented services using the updated data processing systems.

17. The data processing system of claim 16, wherein the operations further comprise:
prior to obtaining the at least the portion of the telemetry data:
obtaining, by the management system, a second portion of telemetry data from the data processing systems, the second portion of telemetry data being based on operation of the data processing systems;
making, by the management system, a determination regarding whether the
second portion of telemetry data is acceptable for use in a process; and
in a first instance of the determination where the second portion of the telemetry data is not acceptable:
establishing at least one of the semantic enrichment classifications based on the determination, the at least one of the semantic enrichment classifications indicating that the portion of the telemetry data is to be semantically enriched.

18. The data processing system of claim 17, wherein making the determination comprises:
sampling the second portion of the telemetry data to obtain samples;
identifying a ratio between a cardinality of a first portion of the samples that are usable in the process to a cardinality of the samples;
comparing the ratio to a threshold ratio; and
in an instance of the comparing where the ratio does not meet the threshold ratio:
concluding that the second portion of the telemetry data is not acceptable for use in the process.

19. The data processing system of claim 18, wherein the threshold ratio is based on the process, and different threshold ratios are associated with different processes based on data needs of the different processes.

20. The data processing system of claim 16, wherein the semantic enrichment classifications are based, at least in part, on an unacceptable usability of the at least the portion of the telemetry data in a process, and the semantically enriched telemetry data being acceptably usable in the process.
